(19) United States
(12) Patent Application Publication
(10) Pub. No.: US 2007/0162577 A1
(43) Pub. Date: Jul. 12, 2007

(54) System for providing managed computing service

(75) Inventors: Peter H. Schow, Longmont, CO (US); Mark A. Son-Bell, Los Altos, CA (US); Gregory A. Williams, Colorado Springs, CO (US); Arieh Markel, Lafayette, CO (US); Carl F. Meske JR., San Jose, CA (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/327,063

(22) Filed: Jan. 6, 2006

(51) Int. Cl. G06F 15/173

(52) U.S. Cl. 709/223

(57) ABSTRACT

A method for providing managed computing service for a plurality of clients using a remote file system that includes obtaining a plurality of service unit files associated with each of the plurality of clients, updating a service unit file in the plurality of service unit files when a service unit is found not current based on the plurality of service unit files, and accessing the service unit file in the plurality of service unit files to update the plurality of clients, wherein the plurality of service unit files are stored and accessed on the remote file system by using a local file system.

### BACKGROUND

Large entities such as corporations, companies, educational institutions, and other organizations have hundreds of interconnected nodes as part of the large entity's information technology (IT) infrastructure. Each node may be a server, desktop computer, laptop computer, or other computer device. The interconnection between nodes is typically achieved using a network with connection devices, such as routers and hubs, and one or more connection mediums, such as standard network cables and wireless devices. By using the interconnection between nodes, large entities are able to provide greater functionality to the entity's employees and customers. Typically, the nodes are heterogeneous in terms of the architecture, applications, and operating system. For example, nodes are often configured and designed for a specific task, such as web server servicing web applications.

Managing the IT infrastructure of a large entity, when hundreds of heterogeneous nodes exist, is a non-trivial task. Specifically, the nodes, network, and all applications must be kept current, operable, and follow performance requirements.

One method for managing the IT infrastructure is for a large entity to have several system administrators, each of whom is responsible for a subset of nodes. Using this solution, management between subsets is often difficult to provide consistency. Accordingly, many large entities contract out portions or all of the IT computing space. Specifically, certain portions of the network may be managed by a business, such as a managed service provider, that specializes in managed computing service. For example, one managed service provider may manage the network, while another managed service provider may manage the personal computers of the employees.

In order to provide the managed computing service, the managed service provider must have access to the portion the managed service provider is managing. Specifically, the managed service provider must be able to determine when the portion is not functioning properly or needs updating. One manner for the managed service provider to access the portion is for the managed service provider to go physically to the large entity or access the network of the large entity remotely.

Once the managed service provider has access to the portion, then the managed service provider may use any number of monitoring tools to track the large entity's IT environment and maintain state of enterprise, configurations, log files, performance metrics. The managed service provider may adjust configuration settings, and update, replace, and add any necessary components.

### SUMMARY

In general, in one aspect, the invention relates to a method for providing managed computing service for a plurality of clients using a remote file system that includes obtaining a plurality of service unit files associated with each of the plurality of clients, updating a service unit file in the plurality of service unit files when a service unit is found not current based on the plurality of service unit files, and accessing the service unit file in the plurality of service unit files to update the plurality of clients, wherein the plurality of service unit files are stored and accessed on the remote file system by using a local file system.

In general, in one aspect, the invention relates to a computer system for providing managed computing services for a plurality of clients using a remote file system that includes a remote file system for storing a plurality of service unit files associated with each of the plurality of clients, and a processor within the computer system for executing software instructions to perform obtaining a plurality of service unit files associated with each of the plurality of clients, updating a service unit file in the plurality of service unit files when a service unit is found not current based on the plurality of service unit files, and accessing the service unit file in the plurality of service unit files to update the plurality of clients, wherein the plurality of service unit files are stored and accessed on the remote file system by using a local file system.

In general, in one aspect, the invention relates to a system for providing managed computing services for a plurality of clients using a remote file system that includes a remote file system for storing a plurality of service unit files associated with each of the plurality of clients, and a service unit manager connected to the remote file system for obtaining a plurality of service unit files associated with each of the plurality of clients, updating a service unit file in the plurality of service unit files when a service unit is found not current based on the plurality of service unit files, and accessing the service unit file in the plurality of service unit files to update the plurality of clients, wherein the plurality of service unit files are stored and accessed on the remote file system by using a local file system.

Other aspects and advantages of the invention will be apparent from the following description and the appended claims.

### BRIEF DESCRIPTION OF DRAWINGS

FIG. 1 shows a flow diagram of a system for providing managed computing service in accordance with one or more embodiments of the invention.

FIG. 2 shows a remote file system for providing managed computing service in accordance with one or more embodiments of the invention.

FIG. 3 shows a flowchart of a method for providing managed computing service at a backend in accordance with one or more embodiments of the invention.

FIG. 4 shows an example of a hierarchical structured file system for providing managed computing service in accordance with one or more embodiments of the invention.

FIG. 5 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method and apparatus for providing access to the IT infrastructure of a large entity. Specifically, embodiments of the invention use a file system which may be shared between the large entity and one or more managed service providers managing the large entity. Portions of the large entity that are being managed may store files on the shared file system. Thus, the managed service provider may access the shared files in order to manage the IT infrastructure of the large entity.

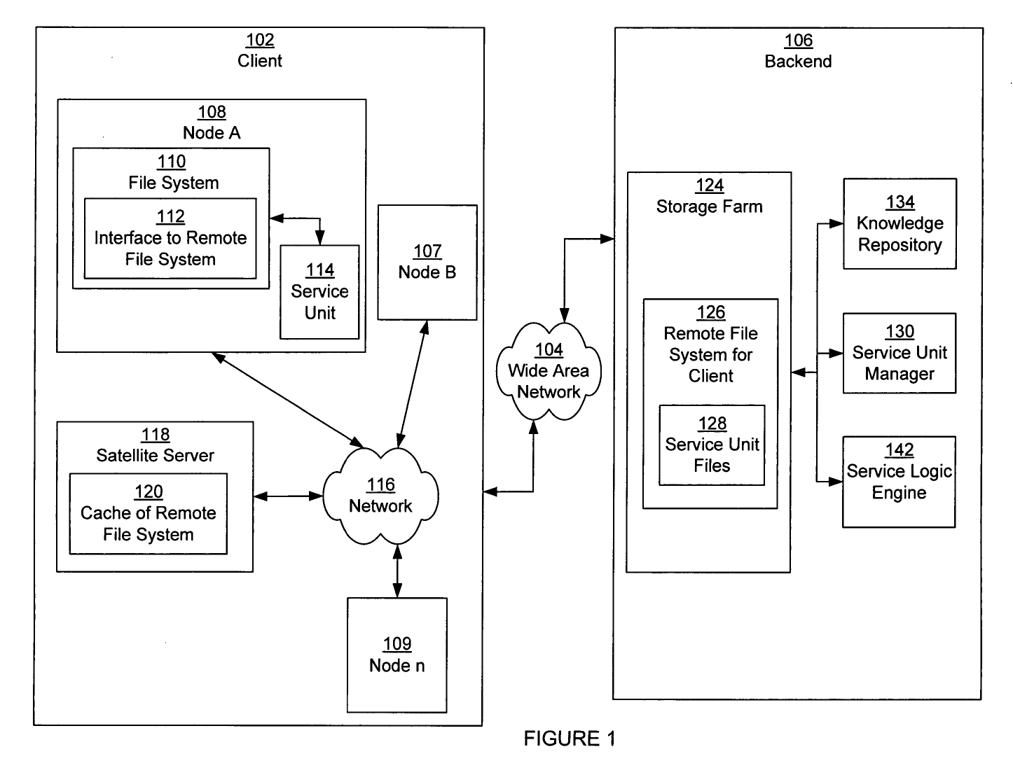

FIG. 1 shows a flow diagram of a system for providing managed computing service in accordance with one or more embodiments of the invention. The system includes a client (102) connected to a backend (106) via the wide area network (104) (e.g., the Internet). Each of these components is described in detail below.

As shown in FIG. 1, the client (102) includes a node (e.g., node A (108), node B (107), node n (109)), a network (116), and satellite server (118). A node (e.g., node A (108), node B (107), node n (109)) may correspond to any type of computing device (e.g., such as a laptop computer, personal digital assistant, server, desktop computer, and the like) or connection device, such as a router or hub. At least one node (e.g., node A (108)) on the client (102) includes a file system (110) and a service unit (114).

The file system (110) may correspond to a file system for the entire client (102) or for a node (e.g., node A (108), node B (107), node n (109)). In one or more embodiments of the present invention, the file system (110) includes an interface to a remote file system (112). The interface to the remote file system (112) provides access to the remote file system for the client (126) (described below). Specifically, in one or more embodiments of the invention, as part of a directory structure for the file system (110) appears the remote file system. For example, a node may have a file system (110) with a “c:” drive which corresponds to a local hard drive, an “a:” drive which corresponds to a local floppy drive, and an “e:” drive which corresponds to the interface to remote file system (112). Accordingly, in one or more embodiments of the invention, a service unit (114), administrator or any application may access files on the remote file system for the client (126) using a similar interface (e.g., user interface (UI) or application programming interface (API)) provided for accessing files on a local disk. Thus, in accordance with one or more embodiments of the invention, the remote file system for the client (126) is simultaneously visible to both the client (102) and the backend (106).

Continuing with FIG. 1, connected to the file system (110) is a service unit (114). The service unit (114) corresponds to any type of device in the IT infrastructure of the client. Specifically, the service unit may be a monitoring device on the node (e.g., node A (108), node B (107), node n (109)), an application, (such as a database, operating system, application), the software for any interconnection devices, such as software for routers and hubs, software for managing a grid, as well as any other number of devices. The service unit (114) includes functionality to access the file system (110) and store files for the service unit on the file system (110). In particular, in one or more embodiments of the invention, because the service unit (114) includes functionality to access the file system (110), the service unit (114) is also able to access the remote file system (126) using the interface to the remote file system (112).

Rather than accessing files on the remote file system, the service unit (114) may be based on the remote file system for the client (126) in accordance with one or more embodiments of the invention. Specifically, all of the files of the service unit may be store on the remote file system for the client (126). Accordingly, the service unit (114) may only be executed by a processor (not shown) on the node (e.g., node A (108)) which accesses the remote file system (126) using the interface to the remote file system (112). Accordingly, new service units (not shown) based on the remote file system for the client (126) may be added remotely by loading the service units on the remote file system for the client (126).

Those skilled in the art will appreciate that rather than the service unit (114) located on the node (e.g., node A (108)), the service unit (114) may optionally be connected to the node (e.g., node A (108), node B (107), node n (109)). Specifically, the service unit (114) may be associated with and provide functionality to multiple nodes (e.g., node A (108), node B (107), node n (109)). For example the service unit may be a router which maintains configuration files using the interface to the remote file system (112) on one of the nodes (e.g., node A (108), node B (107), node n (109)).

Further, those skilled in the art will appreciate that the node (e.g., node A (108), node B (107), node n (109)) may not be located within the parameters of client (102). Specifically, the node (e.g., node A (108), node B (107), node n (109)) may correspond to a laptop computer of a user in transit. Accordingly, in one or more embodiments of the invention, the node (e.g., node A (108), node B (107), node n (109)) may be directly connected to the wide area network (104).

However, when the node (e.g., node A (108), node B (107), node n (109)) is within parameters of the client, a network (116) may be used to connect the nodes (e.g., node A (108), node B (107), node n (109)). The network (116) may correspond to any type of mechanism for connecting nodes (e.g., node A (108), node B (107), node n (109)). Specifically, the network (116) may correspond to direct connections between the nodes (e.g., node A (108), node B (107), node n (109)), one or more local area network (LANs), wide area networks (WANs), etc.

Continuing with FIG. 1, connected to the nodes (e.g., node A (108), node B (107), node n (109))) via a network (116) is a satellite server (118). The satellite server (118) is a server which includes functionality to maintain a cache of the remote file system (120) for the client (102). The cache of the remote file system (120) maintains data that has been recently accessed by the client (102). Accordingly, the satellite server (118) may include a synchronization protocol for synchronizing files between the cache for the remote file system (120) and the remote file system for the client (126). Having a cache for the remote file system (120) reduces bandwidth requirements and increases the availability for the remote file system for the client (126) on the client (102). Alternatively, those skilled in the art will appreciate that the cache for the remote file system (120) may not exist or may be stored in the node (e.g., node A (108), node B (107), node n (109)).

In one or more embodiments of the invention, the backend (106) is connected to the client (102) via the wide area network (104). The backend (106) corresponds to a group of connected servers (not shown) and includes functionality to manage all or a portion of the client (102). Specifically, associated with the backend (106) may be one or more managed service providers, which are contracted by the client (102) to manage the IT infrastructure of the client (102). Accordingly, the backend (106) includes functionality to track changes in the client (102) and maintain state of enterprise, configurations, log files, performance metrics. Further, the backend (106) may include functionality to adjust configuration settings, and update, replace, and add any necessary components or service units (114).

The backend includes a storage farm (124), a knowledge repository (134), a service unit manager (130), and a service logic engine (142). Each of these components is described below.

Continuing with FIG. 1, the storage farm (124), in one or more embodiments of the invention, corresponds to at least one server which manages remote files for several clients (e.g., client (102)). A remote file (e.g., service unit files (128)) corresponds to a file which is not stored on the client (102). Specifically, in one or more embodiments of the invention, each client (102) has a remote file system for the client (126) at the storage farm (124).

In one or more embodiments of the invention, the remote file system (126) stores the service unit files (128) for the client (124). The service unit files (128) may include configuration files, log files, performance measurement files, a copy of the boot image, and other such files. Specifically, the service unit files (128) may correspond to files for the service unit (114). More specifically, rather than having the service unit boot using local files from the file system (110), the service unit may use the service unit files (128) stored on the remote file system for the client (126) in accordance with one or more embodiments of the invention. Further, the service unit files may also include the output from the service unit (110) such as log files and other such files.

Continuing with FIG. 1, in one or more embodiments of the invention, a service logic engine (142) is connected to the storage farm (124). The service logic engine (142) corresponds to a component which includes functionality to monitor each portion of the client (102) for which the backend (106) is responsible. In one or more embodiments of the invention, the service logic engine (142) includes functionality to detect when changes are made to the service unit files (128), modify the format of the service unit files (128) (or any portion thereof) and send notification to or trigger a service unit manager (130) in charge of the service unit (not shown). Alternatively, in one or more embodiments of the invention, the service unit manager (130) may access the service unit files (128) directly.

The service unit manager (130) includes functionality to review the service unit files (128) and determine whether modifications, additions, or deletions to the service unit or service unit files are required. Specifically, the service unit manager (130) includes functionality to manage the service unit through the service unit files (128) and submit notifications if any hardware modifications need to be performed. Those skilled in the art will appreciate that the service unit manager may manage the entire service unit or only a portion of the service unit. Accordingly the service unit manager (130) may review all service unit files (128) associated with a service unit, or the service unit files (128) associated with the portion of the service unit the service unit manager manages (130). Further, the service unit manager (130) may correspond to a software program, a group of employees for the managed service provider, a combination thereof, or virtually any other entity which may manage a service unit (not shown) using the service unit files (128). In order to manage the service unit (not shown), the service unit manager (130) may be connected to a knowledge repository (134) in accordance with one or more embodiments of the invention.

The knowledge repository (134) maintains the current knowledge of all or a subset of the service units (not shown) on the client (102). For example, the knowledge repository (134) may maintain information regarding modifications that should be made to the service unit, a listing of rules for updating the service unit, and other such information that may be required for maintaining the service unit. For example, when a software vendor publishes an update, information regarding the update may be added to the knowledge repository (134). Accordingly, in one or more embodiments of the invention, the knowledge repository (134) may be continuously kept updated by the vendors of the different service units (not shown). Alternatively, the knowledge repository (134) may be updated by a web engine accessing the component vendors' websites. Typically, the knowledge repository (134) is kept continuously updated.

Further, one skilled in the art will appreciate that because communication between client and the backend data center is typically performed using the wide area network, various security measures may be used that are not shown or discussed in FIG. 1. For example, firewalls on both the client and the backend may be used to prevent intruders, data may be encrypted and decrypted using virtually any mechanism known in the art, authentication and authorization may be performed, etc. Additionally, authentication and authorization may be performed on a per client basis, based on the node executing the service unit, the service unit, a user, etc.

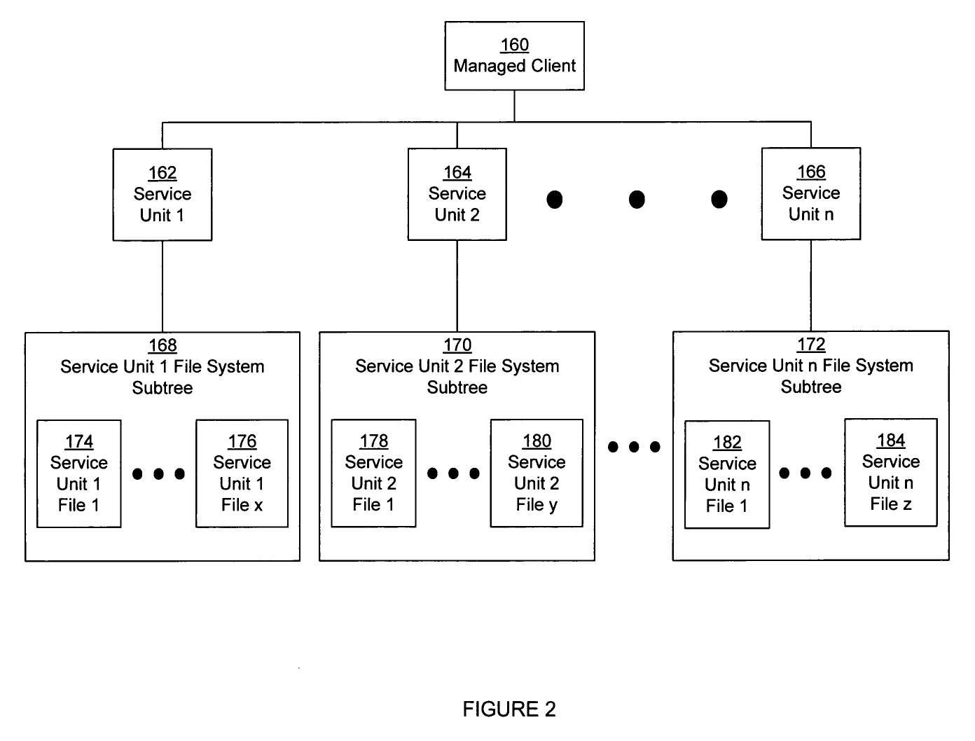

FIG. 2 shows a remote file system for providing managed computing service in accordance with one or more embodiments of the invention. Specifically, FIG. 2 shows a directory structure in the remote file system that allows for the different service units to be managed. As shown in FIG. 2, each service unit (e.g., service unit 1 (162), service unit 2 (164), service unit n (166)) has a subtree in the file system (e.g., service unit 1 file system subtree (168), service unit 2 file system subtree (170), service unit n file system subtree (172)). In one or more embodiments of the invention, each subtree (e.g., service unit 1 file system subtree (168), service unit 2 file system subtree (170), service unit n file system subtree (172)) corresponds to a folder in the remote file system.

Accordingly, each subtree (e.g., service unit 1 file system subtree (168), service unit 2 file system subtree (170), service unit n file system subtree (172)) includes the files particular to the service unit (e.g., service unit 1 file 1 (174), service unit 1 file x (176), service unit 2 file 1 (178), service unit 2 file y (180), service unit n file 1 (182), service unit n file z (184)). Thus, when the service unit (e.g., service unit 1 (162), service unit 2 (164), service unit n (166)) or the service unit manager wants to access the files for the service unit (e.g., service unit 1 file 1 (174), service unit 1 file x (176), service unit 2 file 1 (178), service unit 2 file y (180), service unit n file 1 (182), service unit n file z (184)), the service unit (e.g., service unit 1 (162), service unit 2 (164), service unit n (166)) or the service unit manager only need to access the folder for the service unit (e.g., service unit 1 (162), service unit 2 (164), service unit n (166)). Therefore, the exchange of information associated with the service unit (e.g., service unit 1 (162), service unit 2 (164), service unit n (166)) may be performed by simply accessing a file as if the file was local.

Those skilled in the art will be able to appreciate that while FIG. 2 shows the service units files being mutually exclusive, a service unit files may be a subtree of another service unit file system subtree (e.g., service unit 1 file system subtree (168), service unit 2 file system subtree (170), service unit n file system subtree (172)). Further, each service unit file system subtree (e.g., service unit 1 file system subtree (168), service unit 2 file system subtree (170), service unit n file system subtree (172)) may be located in different levels of the file system hierarchy from other file system subtrees (e.g., service unit 1 file system subtree (168), service unit 2 file system subtree (170), service unit n file system subtree (172)). For example, the path to the network service unit subtree which is managed by a single service unit manager may be E:/client_A/network/ while there may be several operating system service units with paths to the specific service unit file system subtrees E:/client_A/Operating_System/Unix and E:/client_A/Operating_System/Solaris.

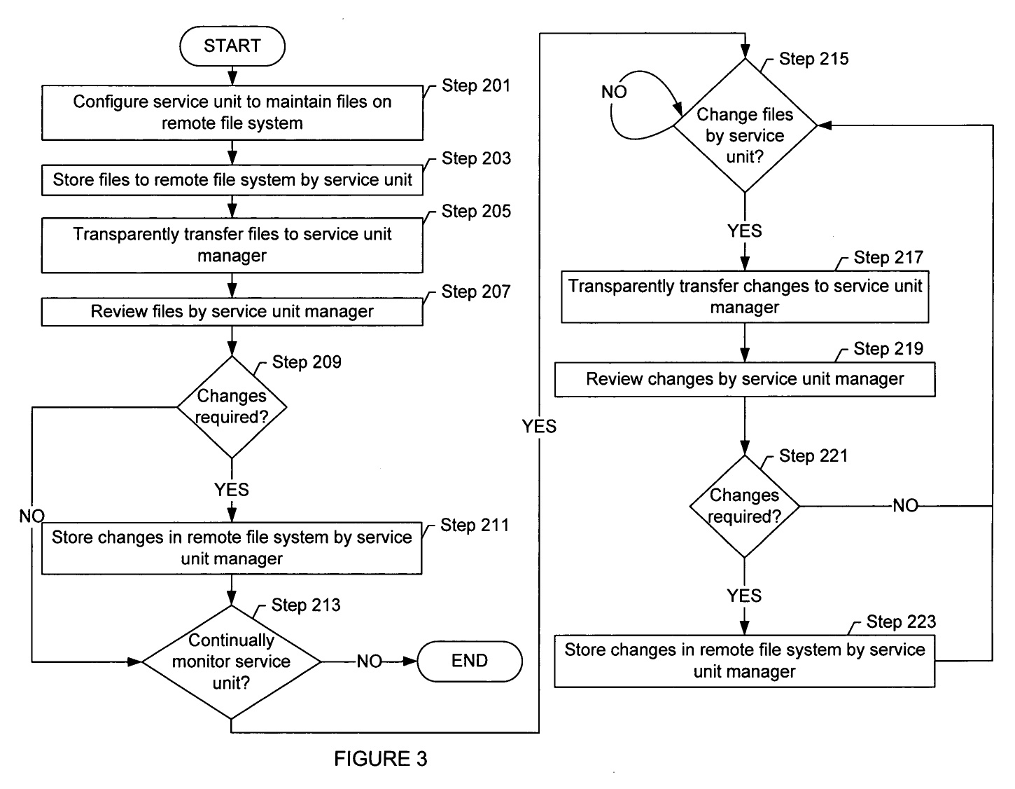

FIG. 3 shows a flowchart of a method for providing managed computing service at a backend in accordance with one or more embodiments of the invention. Initially, the service unit is configured to maintain files on the remote file system (Step 201). As part of configuring the service unit to maintain files on the remote file system, the remote file system for the client is typically first mounted on the node. Mounting the remote file system for the client may be performed in a central location of the client. Specifically, a user or administrator typically does not need to specify each node on which to mount the remote file system for the client. Once the remote file system for the client is mounted, then at startup, a file system manager is able to discover the remote file system for the client and add the remote file system interface to the file system. After adding the interface to the remote file system, the patch name for the service unit to save and retrieve files may be changed to the path name for the storage location of the service unit files on the remote director. For example, rather than storing the files on a c: drive, the path name may be changed to store files on an e: drive (or any drive associated with the remote file system).

Next, the service unit stores the files to the remote file system (Step 203). As stated above, storing the files to the remote file system may be performed as easily as storing the files to a local directory.

Alternatively, rather than configuring the service unit to store the service unit files on the remote file system, the service unit may be installed on the remote file system. Accordingly, the client may be configured to access the remote file system in order to execute the service unit. By using the interface to the remote file system, executing the service unit may be performed as if the service unit were stored on local file system of the client.

Returning to FIG. 3, at this stage, the files may be cached on a satellite server in the cache for the remote file system. When the files are cached on a satellite server, then the files may be transferred periodically or immediately to the backend using virtually any synchronization protocol known in the art. Accordingly, after a service unit stores the files on the remote file system and transferred to the storage farm on the backend, the files may be transferred to the service unit manager (Step 205).

After transferring the files to the service unit manager, in one or more embodiments of the invention, the service unit manager reviews the files (Step 207). For example, the service unit manager may check the log files to determine how the client or a portion of the client is operating, review the configuration files to determine whether changes are made by the client to the configuration files, or review any other of the possible service unit files to determine the state of the service unit.

Once the files are reviewed by the service unit manager, a determination is made whether changes are required to the service unit based on the files (Step 209). Specifically, in one or more embodiments of the invention, the service unit manager may compare the configuration files with an ideal configuration in the knowledge repository, review the log files to determine whether configuration changes are required, update the boot image using new knowledge in the knowledge repository, update a schema when the service unit is a database to provide better performance, or perform virtually any other updating or comparison. The knowledge repository may be continuously populated, for example, by the vendor's of the service unit sending notifications of possible updates to the service unit, an update engine which visits vendor's websites, or using virtually any other method which allows for the knowledge repository to obtain information about the service units. Accordingly, by using a knowledge repository, multiple clients may be managed by only maintaining the data in the knowledge repository.

Continuing with FIG. 3, if changes are required, then the changes are stored by the service unit manager (Step 211). For example, the service unit manager may access a configuration file of the service unit and adjust through the configuration settings how the service unit operates. Once the service unit manager adjusts the configuration settings, then the next time the service unit accesses the configuration file, the service unit is able to access the adjusted configuration settings. Accordingly, the next time the service unit accesses the service unit files, the service unit is able to access updated service unit files.

Those skilled in the art will appreciate that certain changes, such as adding or removing nodes must be performed on site. Accordingly, in this stage rather than performing the changes by accessing the file, the changes may be performed by physically accessing the client or any other method necessary. Further, the service unit manager may send a signal to the service unit that changes are required. The signal may include information about the changes to be performed or may simply specify that the service unit should check the service unit files.

Those skilled in the art will appreciate that in a system in which a cache is used and files may be updated by at least two components (i.e., service unit and service unit manager), cache coherency problems may exist. Specifically, the service unit manager may modify the service unit files at the same time that the service unit is modifying the cache of the service unit files. To solve the cache coherency problems, when any component modifies a file, the satellite server or the storage farm may send a message to inform the file not being modified that a modification is occurring. Further, embodiments of the invention may use the knowledge that certain files may be (i) modified only by the client and read by the backend; or (ii) modified only by the backend and read by the client. Accordingly, for the aforementioned certain files, cache coherency problems may be alleviated. Those skilled in the art will appreciate that there are several mechanism not stated above for solving cache coherency in a distributed system which may be used in the current system.

Continuing with FIG. 3, next, a determination is made whether the service unit is to be continually monitored (Step 213). Specifically, if the client has a contract with the service unit manager to continuously monitor the service unit. If the service unit should be continuously monitored, then a determination is made whether the service unit made changes to the files (Step 215). Determining whether changes are made to the files may be performed, for example, by checking a timestamp stored in the metadata of a file. If the timestamp shows is different from the last time the files were reviewed, then the client has modified the files. Making changes to the files may include modifying configuration files or adding in performance analysis. As stated above, cache coherency problems may exist when modifying a file. Accordingly, when files are modified, then virtually any of the aforementioned steps for solving the cache coherency issues may be used.

Continuing with FIG. 3, if the service unit makes changes to the files, then the changes are transferred to the service unit manager (Step 217). Transferring the changes to the service unit manager may be performed in a manner similar to transferring the files (which was described in Step 205 above). Next, the changes are reviewed by the service unit manager (Step 219). While reviewing the changes, a determination is made whether any changes are required (Step 221). If changes are not required, then the service unit manager waits unit more changes are determined to be made by the service unit (Step 215). Alternatively, if any changes are required, then the changes are stored in the remote file system (Step 223). Once the changes are made, then the service unit manager may wait until more changes are determined to be made by the service unit (Step 215).

Alternatively, those skilled in the art will appreciate that, while not shown, the service unit manager may not wait for the changes to files to be made by the service unit. Rather, at any stage in the method, the service unit manager may adjust the files for the service unit. Specifically, the service unit may check the files on a certain interval or when new data is added to the knowledge repository. Further, the service unit manager may add additional resources, such as more nodes to the service unit.

In one or more embodiments of the invention, the service unit manager does not need to know which service unit is being serviced. Specifically, embodiments of the invention provide a uniform method for accessing service unit files. Specifically, the service unit may be based on the location of the service unit files within the remote file system. Further, in one or more embodiments of the invention, the service unit manager is able to manage the service unit without knowledge of the platform of the node on which the service unit executes or the type of device of the node. Accordingly, the service unit manager is able to manage service units executing on heterogeneous nodes and using heterogeneous operating systems.

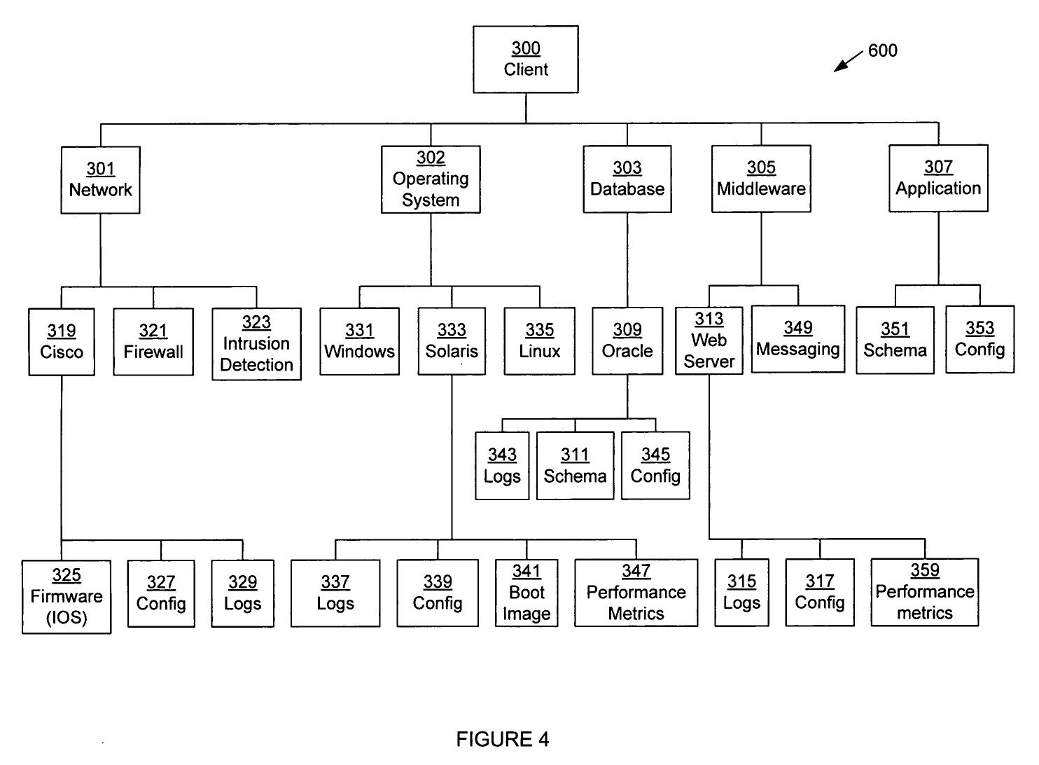

FIG. 4 shows an example of a hierarchical structured file system (600) for providing managed computing service in accordance with one or more embodiments of the invention. In this example, consider the case in which the client (300) has several service units, a network system (301), several heterogeneous operating systems (302), a database (303), middleware (305), and application software (307). The service units each have folders for the service units. Specifically, the network service unit folder (301) has network service unit files, such as files for a Cisco router (e.g., firmware Cisco IOS files (325), configuration files (config) (327), log files (logs) (329)) in a Cisco router folder (319), firewall files (321), intrusion detection files (323). The operating system service unit folder (302) has operating system service unit files, such as Windows files (331), Solaris files in a Solaris folder (333) (e.g., logs (337) config (339), boot image files (341) performance metric files (347)), Linux files (335), etc. The database service unit folder (303) has database service unit files, such as Oracle files (e.g., logs (343), schema (311), config (345)) in an Oracle folder (309). The middleware service unit folder (305) has middleware service unit files, such as web server files (e.g., logs (315), config (317), performance metrics (359), etc.) in a web server folder (313) and messaging files (349). The application service unit folder (307) has application service unit files (e.g., schema (351), config (353), etc.). Those skilled in the art will appreciate that the aforementioned listing of the files may be only a subset of the files for the client (300). Each of the service units are managed by one or more service unit managers. For example, a service unit manager may manage the entire network files (301) or only the Cisco files (319) (e.g., firmware Cisco IOS files (325), configuration files (config) (327), log files (logs) (329)).

Specifically, suppose there is a service unit manager which manages the database service unit (303) and, in particular, an Oracle database. The database servers may use the Oracle database files (309) such as the schema files (311) to service queries and add entries. Because the files are shared on the remote file system, the service unit manager, which may be physically located across the world, may access the schema files to update the schema for the database. Moreover, both the access by the database and the access by the service unit manager may be performed as if the files were local.

As another example, consider the case in which a service unit manager is responsible for managing only the web server (313). While monitoring a log file (315) for the web server (313), the service unit manager discovers that midday, the number of queries to the web server increases to the extent that response time is low. Accordingly, the service unit manager may access the web server configuration file (317) and make appropriate corrections. Alternatively, the service unit manager may add resources to service queries during the midday.

As shown above, by using the model of a file system to transfer data, both the service unit and the service unit manager may access the required files easily as if the files were stored locally.

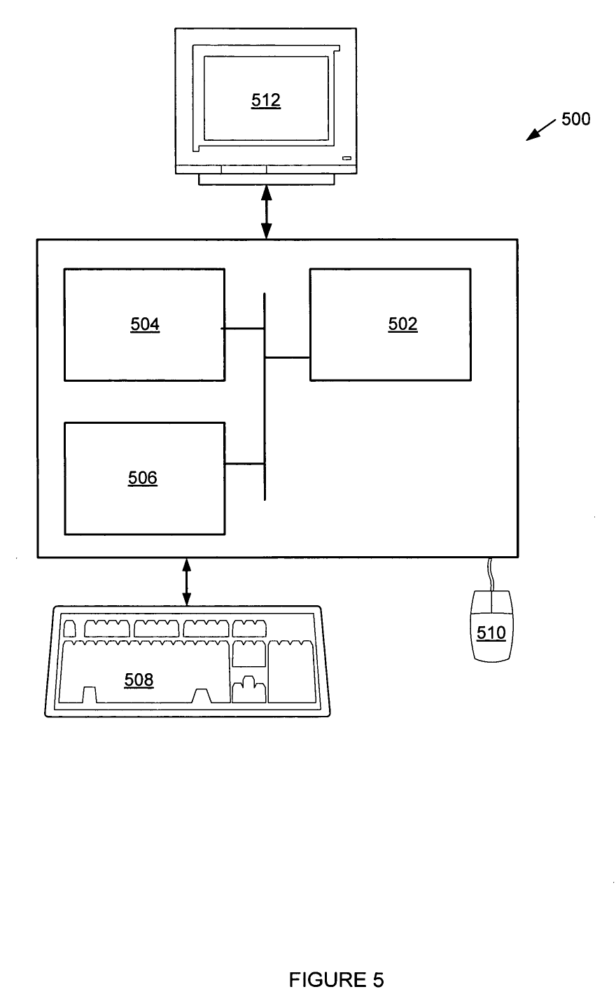

The invention may be implemented on virtually any type of computer regardless of the platform being used. For example, as shown in FIG. 5, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., service logic engine, service unit manager, service unit files, service unit, file system, and the like.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention may include one or more of the following advantages. First by storing files to a remote file system, the complex set of user interfaces, protocols and system management tools that a managed service provider previously must use is hidden and in some cases eliminated. Specifically, because both the service unit and the service unit manager at the managed service provider may access the same set of files and the actual transfer of the data in the files are hidden. More specifically, both the service unit and the service unit manager may modify the files as if the files were local even though the service unit and the service unit manager are physically separated across and internet in accordance with one or more embodiments of the invention.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for providing managed computing service for a plurality of clients using a remote file system comprising:
obtaining a plurality of service unit files associated with each of the plurality of clients;
updating a service unit file in the plurality of service unit files when a service unit is found not current based on the plurality of service unit files; and
accessing the service unit file in the plurality of service unit files to update the plurality of clients,
wherein the plurality of service unit files are stored and accessed on the remote file system by using a local file system.

2. The method of claim 1, wherein the plurality of service unit files correspond to the files of a service unit associated with each of the plurality of clients, and wherein the service unit is executed from the remote file system by each of the plurality of clients.

3. The method of claim 1, wherein the remote file system is visible to the plurality of clients and a backend.

4. The method of claim 1, wherein the plurality of service unit files is stored in a hierarchy.

5. The method of claim 4, wherein a service unit corresponds to a subtree of the hierarchy of service unit files.

6. The method of claim 1, wherein a plurality of service units associated with the plurality of service unit files is stored uniformly.

7. The method of claim 1, wherein updating a service unit file when a service unit is found not current is performed continuously.

8. The method of claim 1, further comprising:
authenticating each of the plurality of clients.

9. A computer system for providing managed computing services for a plurality of clients using a remote file system comprising:
a remote file system for storing a plurality of service unit files associated with each of the plurality of clients; and
a processor within the computer system for executing software instructions to perform:
obtaining a plurality of service unit files associated with each of the plurality of clients;
updating a service unit file in the plurality of service unit files when a service unit is found not current based on the plurality of service unit files; and
accessing the service unit file in the plurality of service unit files to update the plurality of clients,
wherein the plurality of service unit files are stored and accessed on the remote file system by using a local file system.

10. The computer system of claim 9, wherein the plurality of service unit files correspond to the files of a service unit associated with each of the plurality of clients, and wherein the service unit is executed from the remote file system by each of the plurality of clients.

11. The computer system of claim 9, wherein the remote file system is visible to the plurality of clients and a backend.

12. The computer system of claim 9, wherein the plurality of service unit files is stored in a hierarchy.

13. The computer system of claim 12, wherein a service unit corresponds to a subtree of the hierarchy of service unit files.

14. The computer system of claim 9, wherein a plurality of service units is stored uniformly.

15. The computer system of claim 9, wherein updating a service unit when a service unit is found not current based on the plurality of service unit files is performed continuously.

16. The computer system of claim 9, further comprising:
authenticating each of the plurality of clients.

17. A system for providing managed computing services for a plurality of clients using a remote file system comprising:
a remote file system for storing a plurality of service unit files associated with each of the plurality of clients; and
a service unit manager connected to the remote file system for:
obtaining a plurality of service unit files associated with each of the plurality of clients;
updating a service unit file in the plurality of service unit files when a service unit is found not current based on the plurality of service unit files; and
accessing the service unit file in the plurality of service unit files to update the plurality of clients,
wherein the plurality of service unit files are stored and accessed on the remote file system by using a local file system.

18. The system of claim 17, wherein the plurality of clients have heterogeneous operating systems.

19. The system of claim 18, wherein updating a service unit when a service unit is found not current based on the plurality of service unit files comprises:
determining whether the service unit file is current by accessing a knowledge repository.

20. The system of claim 19, wherein the knowledge repository is updated by the vendor of the service unit.
